(19) United States
(12) Patent Application Publication
(10) Pub. No.: US 2017/0361567 A1
(43) Pub. Date: Dec. 21, 2017

(54) LIGHT WEIGHT TEXTILE STRUCTURE FOR ARC FLASH PROTECTION WITH MINIMUM ARC RATING

(71) Applicant: Honeywell International Inc., Morris Plains, NJ (US)

(72) Inventor: Raj Kamal Prasad, Hyderabad (IN)

(21) Appl. No.: 15/619,209

(22) Filed: Jun. 9, 2017

(30) Foreign Application Priority Data
Jun. 16, 2016 (IN) 201611020627

(51) Int. Cl. B32B 5/26; B32B 7/08; D05B 3/24

(52) U.S. Cl. CPC B32B 5/26; D05B 3/243; B32B 7/08; B32B 2262/0246; B32B 2307/20

(57) ABSTRACT

Embodiments relate generally to systems and methods for providing protection from arc flash. A material for arc flash protection may comprise a first layer of textile material configured to face an arc flash, the first layer comprising a woven or knitted fabric; and a second layer of textile material configured to face a user's skin, the second layer comprising a quilted fabric having at least one oxidized polyacrylonitrile fiber. A method of forming a material for protection from arc flash may comprise providing a first layer of textile material configured to face an arc flash, the first layer comprising a woven or knitted fabric; quilting one or more layers of material to form a second layer of textile material configured to face a user's skin, the second layer comprising at least one oxidized polyacrylonitrile fiber; and attaching the first layer to the second layer to form a completed textile.

### CROSS-REFERENCE TO RELATED APPLICATIONS

The present application claims priority to India Provisional Patent Application Serial No. 2016/11020627 filed Jun. 16, 2016 by Raj Kamal Prasad and entitled “Light Weight Textile Structure for Arc Flash Protection with Minimum Arc Rating” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An arc flash (or arc blast) is a type of electrical discharge resulting from a low impedance connection to ground or another voltage phase in an electrical system. In particular, the arc flash is produced by an electrical breakdown of the resistance of air which occurs when there is sufficient voltage in an electrical system and a path to ground or lower voltage. An arc flash typically releases a massive amount of energy that vaporizes metal conductors in the electrical system, blasting molten metal and expanding plasma outward from the source, and produces a shock wave due to the rapid heating of the gases in the vicinity. The arc flash and the metal plasma produced by the flash rapidly release tremendous amounts of electromagnetic radiation (e.g., light energy ranging from infrared to ultraviolet wavelengths), and this electromagnetic radiation rapidly heats the surfaces that it contacts. For example, the infrared radiation generated during an arc flash can cause severe burns to the unprotected or under-protected skin of individuals in the vicinity of the arc flash.

In view of the dangers posed by arc flashes, protective clothing systems called arc flash suits have been developed to protect workers at risk of exposure to arc flashes, such as electrical workers and electricians. Such suits are designed to provide varying degrees of protection to the wearer, with the requisite or recommended level of protection being determined by the severity of the arc flash that might be encountered while performing work. In order to provide the desired level(s) of protection, these arc flash suits are typically made from relatively heavy fabrics, the prevailing theory and principle of operation being that heavy fabrics block the electromagnetic radiation and provide insulation from the radiant heating caused by the arc flash. However, suits made from such heavy fabrics often become uncomfortable when worn for prolonged periods of time owing, at least in part, to the low air permeability of the heavy fabrics.

Accordingly, there is a need for lighter weight textile materials that protect from the radiation (e.g., near-infrared radiation) generated by an arc flash and are suitable for use in making garments that are comfortable to wear.

### SUMMARY

In an embodiment, a material for arc flash protection may comprise a first layer of textile material configured to face an arc flash, the first layer comprising a woven or knitted fabric; and a second layer of textile material configured to face a user's skin, the second layer comprising a quilted fabric having at least one oxidized polyacrylonitrile fiber.

In an embodiment, a method of forming a material for protection from arc flash may comprise providing a first layer of textile material configured to face an arc flash, the first layer comprising a woven or knitted fabric; quilting one or more layers of material to form a second layer of textile material configured to face a user's skin, the second layer comprising at least one oxidized polyacrylonitrile fiber; and attaching the first layer to the second layer to form a completed textile.

In an embodiment, a personal protection equipment textile may comprise a first layer of woven or knitted material configured to face an arc flash; and a second layer configured to face a user's skin, wherein the second layer is formed by quilting a nonwoven fabric to a woven or knitted fabric, wherein the second layer comprises at least one oxidized polyacrylonitrile fiber, and wherein the total areal density of the personal protection equipment textile is less than approximately 500 grams per square meter.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an exploded view of a textile for arc flash protection according to an embodiment.

FIG. 2 illustrates a perspective view of a textile for arc flash protection according to an embodiment.

FIG. 3 illustrates a cross-sectional view of a textile for arc flash protection according to an embodiment.

FIGS. 4A-4C illustrate additional detailed views of a textile for arc flash protection according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for providing arc flash protection in personal protection equipment (PPE) garments.

Typically, arc flash protective clothing falls into four categories of protection, with PPE Category 4 having the highest protection levels. Category 4 materials may have an arc rating of at least 40 cal/cm2 (as per NFPA 70E). The majority of arc flash protective materials (or clothing) made for PPE Category 4 are made from multi-layer fabric combinations and are of heavier weight.

Typically, Category 4 materials fit into different areal density or grams per square meter (GSM) ranges. Flame resistant (FR) Treated Cotton or Cotton/Nylon Blended fabric combinations may have an areal density of approximately 600 GSM. Aramid/Mod acrylic/synthetic cellulosic Blended Fabric combinations may have an areal density of approximately 530 GSM. Melamine/PBO/PBI/Novoloid/OPAN/Aramid Blended Fabric combinations may have an areal density of approximately 375 GSM.

The majority of arc protection textiles fall within the first two types of materials (which have densities higher than 500 GSM) and, while the third type has a lower areal density, the fibers used in the materials are a premium product with a premium (and significantly higher) price. Due to the heavier densities of the materials, garments made out of these textiles may be uncomfortable to users during their work periods. Particularly, it may be difficult to wear such a heavy garment for long periods of time for users who are located in warmer or more humid environments. Currently, there is a demand for price competitive light-weight options for arc flash protection for Category 4 (as per NFPA 70E).

Embodiments described herein include a light-weight textile structure for arc flash protection, where the material comprises two or more layers of textile articles. Layer 1 may face the arc flash, and may comprise a woven fabric. Layer 2 may comprise a quilted fabric consisting of a blend of Para Aramid and oxidized polyacrylonitrile (OPAN) fiber in one of the components. Layer 2 may comprise a quilted fabric structure comprising a nonwoven fabric placed over a woven fabric, wherein the nonwoven fabric may comprise at least two fibers. Approximately 40-80 wt % of the nonwoven fabric may comprise a para-aramid, and approximately 20-60 wt % of the nonwoven fabric may comprise an OPAN fiber. The woven fabric used in both Layer 1 and Layer 2 may comprise four or more fibers, including a meta-aramid fiber. Approximately 40-80 wt % of the woven fabrics may comprise the meta-aramid fiber. The disclosed textile structure may have a minimum arc rating (such as Arc Thermal Performance Value (APTV) or Energy Breakopen Threshold (EBT50)) of 40 cal/cm², when measured in accordance with ASTMF 1959/F1959M-14 or IEC61482-1-1:2009 (method A).

In some embodiments, the nonwoven fabric of the second layer may be formed using spun-laced methods, needle-punching or a combination thereof. In some embodiments, the nonwoven material of the second layer may comprise an areal density in between approximately 60-150 GSM.

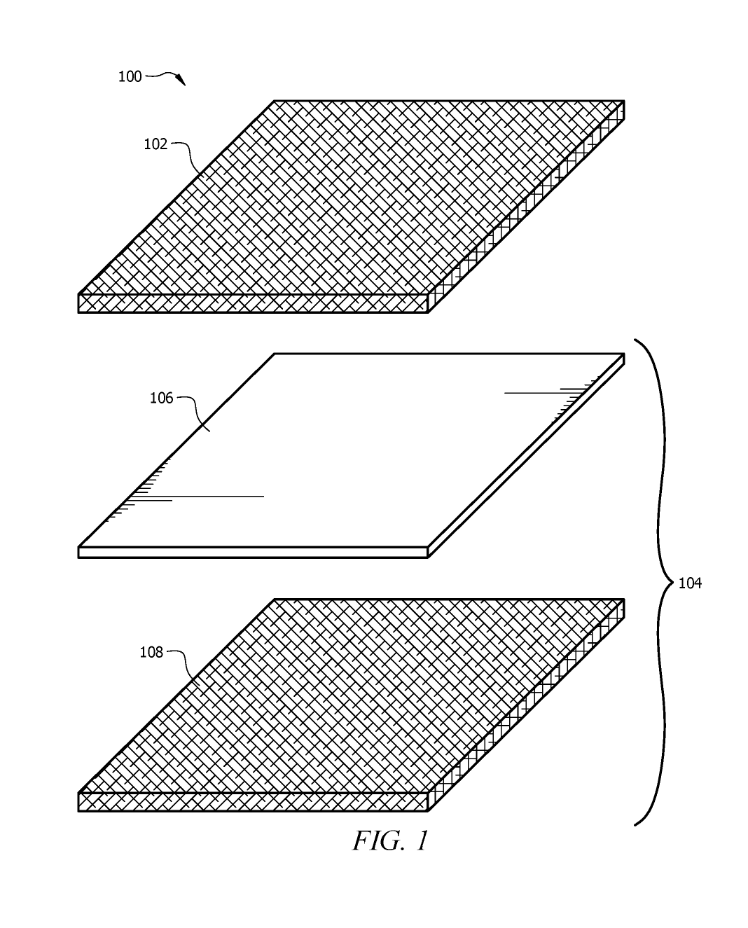

Referring to FIG. 1, an exploded view of the material 100 is shown. A first layer 102 may comprise a woven material comprising a mixture of aramid materials. In some embodiments, the first layer 102 may comprise approximately 200 GSM. In some embodiments, the first layer 102 may comprise a twill weave fabric. In some embodiments, the mixture of the first layer 102 may comprise approximately 55% Meta-Aramid, approximately 25% Lenzing Ry, approximately 15% PET, and approximately 5% Para-Aramid.

A second layer 104 may comprise a first fabric 106 comprising a conductive material. In some embodiments, the first fabric 106 may comprise approximately 75 GSM. In some embodiments, the first fabric 106 may comprise a needle punched felt. In some embodiments, the mixture of the first fabric 106 may comprise approximately 40% OPAN fiber, and approximately 60% Para-Aramid felt.

The second layer 104 may also comprise a second fabric 108 comprising a mixture of aramid materials. In some embodiments, the second layer 104 may comprise approximately 200 GSM. In some embodiments, the second layer 104 may comprise a twill weave fabric. In some embodiments, the mixture of the second layer 104 may comprise approximately 55% Meta-Aramid, approximately 25% Lenzing Ry, approximately 15% PET, and approximately 5% Para-Aramid.

The first fabric 106 and the second fabric 108 may be quilted together to form the second layer 104. In some embodiments, the total areal density of the material 100 including the first layer 102 and the second layer 104 may comprise an areal density of less than approximately 600 GSM. In some embodiments, the total areal density of the material 100 including the first layer 102 and the second layer 104 may comprise an areal density of less than approximately 500 GSM. In some embodiments, the total areal density of the material 100 including the first layer 102 and the second layer 104 may comprise an areal density of approximately 475 GSM.

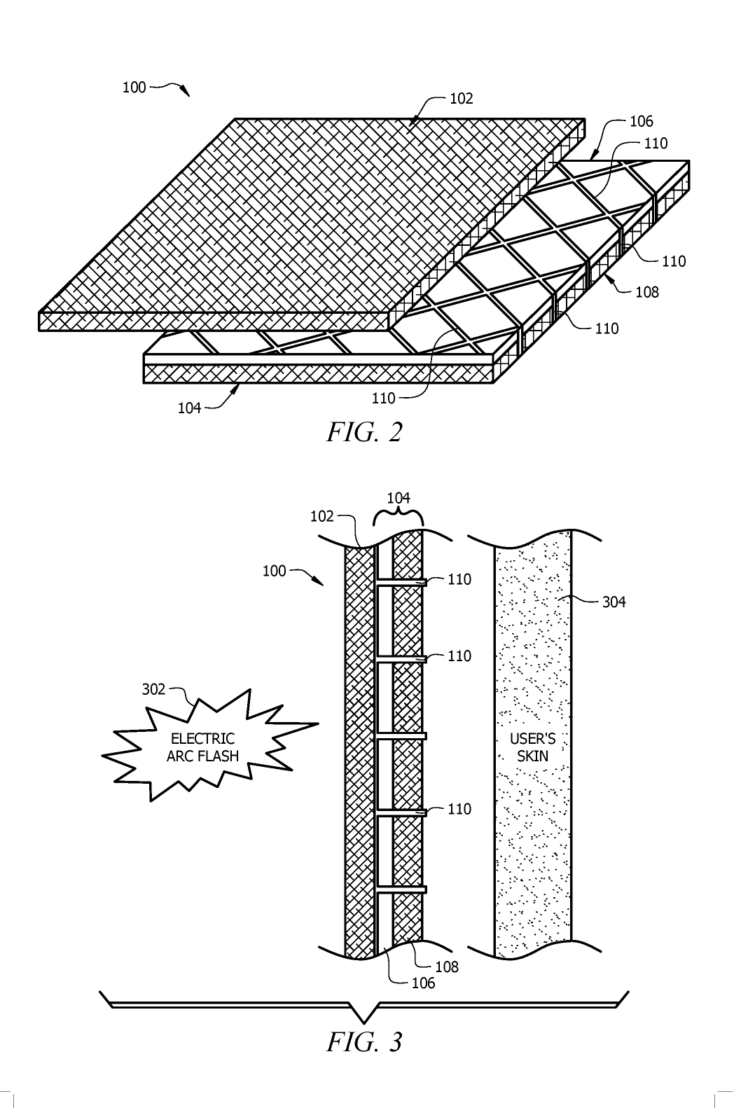

As shown in FIG. 2, the first layer 102 may be placed over the second layer 104, wherein the first fabric 106 is located between the first layer 102 and the second fabric 108 of the second layer 104. As described above, the first fabric 106 and the second fabric 108 of the second layer 104 may be quilted together using stitching 110. The quilting pattern in stitching 110 may be varied based on the application of the material 100. In some embodiments, the first layer 102 and the second layer 104 may be stitched together around the edges of the garment that is formed of the two layers, wherein no other attachment means may be used between the two layers.

Referring to FIG. 3, a cross-sectional view of the material 100 is shown. The first layer 102 may form the outer layer of a garment, while the second layer 104 may form the inner layer of the garment. The second layer 104 may contact or been near the user's skin 304. When the user contacts an electric arc flash 302, the garment may dissipate and/or absorb the electric arc flash 302. The air pockets located between the first layer 102 and the second layer 104 aid in dissipating the electric arc flash 302, protecting the user's skin 304. In some embodiments, it may provide increased protection to have the heavier layer, the second layer 104, on the interior of the garment.

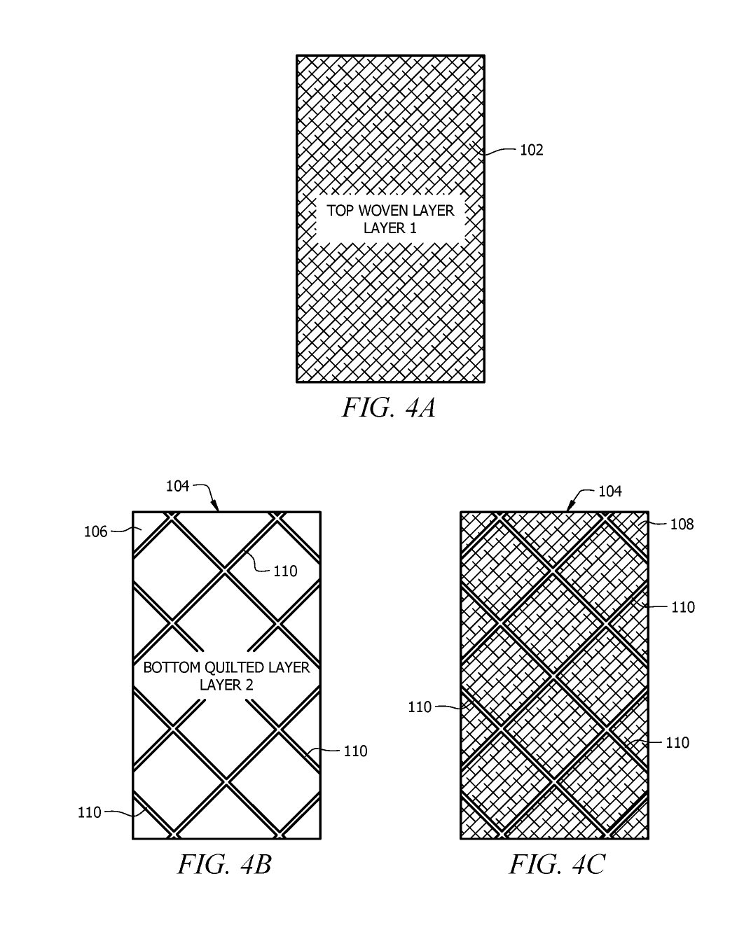

FIGS. 4A-4C illustrate additional views of the layers of the material 100 (described above). FIG. 4A shows the first layer 102, wherein the first layer 102 may comprise a woven material. FIG. 4B illustrates one side of the second layer 104 comprising the first fabric 106. The first fabric 106 may be quilted with stitching 110. FIG. 4C illustrates a second side of the second layer 104 comprising the second fabric 108. The second fabric 108 may be quilted to the first fabric 106 with stitching 110.

Embodiments of the disclosure may comprise a material for arc flash protection comprising: a first layer of textile material configured to face the arc flash comprising a woven or knitted fabric; and a second layer of textile material configured to face a user's skin comprising a quilted fabric having at least one oxidized polyacrylonitrile (OPAN) fiber.

In an embodiment of the material, the material comprises an areal density of less than approximately 600 GSM. In an embodiment of the material, the material comprises an areal density of less than approximately 500 GSM. In an embodiment of the material, the material comprises an areal density of approximately 475 GSM. In an embodiment of the material, the first layer comprises a combination of four or more fibers. In an embodiment of the material, the first layer comprises approximately 40-80 wt % meta-aramid fibers. In an embodiment of the material, the second layer comprises a nonwoven fabric placed over a woven or knitted fabric. In an embodiment of the material, the nonwoven fabric of the second layer comprises at least two fibers. In an embodiment of the material, the nonwoven fabric of the second layer comprises approximately 40-80 wt % of para-aramid fibers and approximately 20-60 wt % of OPAN fibers. In an embodiment of the material, the woven or knitted fabric of the second layer comprises a combination of four or more fibers. In an embodiment of the material, the woven or knitted fabric of the second layer comprises approximately 40-80 wt % meta-aramid fibers. In an embodiment of the material, the nonwoven fabric of the second layer is formed by one of: spunlacing, needle-punching, or a combination thereof. In an embodiment of the material, the nonwoven fabric of the second layer comprises an areal density of between approximately 60 and 150 GSM.

Having described various devices and methods herein, exemplary embodiments or aspects can include, but are not limited to:

In a first embodiment, a material for arc flash protection may comprise a first layer of textile material configured to face an arc flash, the first layer comprising a woven or knitted fabric; and a second layer of textile material configured to face a user's skin, the second layer comprising a quilted fabric having at least one oxidized polyacrylonitrile fiber.

A second embodiment can include the material of the first embodiment, wherein the material comprises an areal density of less than approximately 600 grams per square meter.

A third embodiment can include the material of the first or second embodiments, wherein the material comprises an areal density of less than approximately 500 grams per square meter.

A fourth embodiment can include the material of any of the first to third embodiments, wherein the material comprises an areal density of approximately 475 grams per square meter.

A fifth embodiment can include the material of any of the first to fourth embodiments, wherein the first layer comprises a combination of four or more fibers.

A sixth embodiment can include the material of any of the first to fifth embodiments, wherein the first layer comprises approximately 40-80 wt % meta-aramid fibers.

A seventh embodiment can include material of any of the first to sixth embodiments, wherein the second layer comprises a nonwoven fabric placed over a woven or knitted fabric.

An eighth embodiment can include the material of the seventh embodiment, wherein the nonwoven fabric of the second layer comprises at least two fibers.

A ninth embodiment can include the material of the seventh or eighth embodiments, wherein the nonwoven fabric of the second layer comprises approximately 40-80 wt % of para-aramid fibers and approximately 20-60 wt % of oxidized polyacrylonitrile fibers.

A tenth embodiment can include the material of any of the seventh to ninth embodiments, wherein the woven or knitted fabric of the second layer comprises a combination of four or more fibers.

An eleventh embodiment can include the material of any of the seventh to ninth embodiments, wherein the woven or knitted fabric of the second layer comprises approximately 40-80 wt % meta-aramid fibers.

A twelfth embodiment can include the material of any of the seventh to ninth embodiments, wherein the nonwoven fabric of the second layer is formed by one of: spunlacing, needle-punching, or a combination thereof.

A thirteenth embodiment can include the material of any of the seventh to ninth embodiments, wherein the nonwoven fabric of the second layer comprises an areal density of between approximately 60 and 150 grams per square meter.

In a fourteenth embodiment, a method of forming a material for protection from arc flash may comprise providing a first layer of textile material configured to face an arc flash, the first layer comprising a woven or knitted fabric; quilting one or more layers of material to form a second layer of textile material configured to face a user's skin, the second layer comprising at least one oxidized polyacrylonitrile fiber; and attaching the first layer to the second layer to form a completed textile.

A fifteenth embodiment can include the method of the fourteenth embodiment, further comprising shaping the completed textile into a personal protection equipment to be worn by a user.

A sixteenth embodiment can include the method of the fourteenth or fifteenth embodiments, wherein quilting one or more layers comprises placing a nonwoven fabric over a woven or knitted fabric, and quilting the nonwoven fabric to the woven or knitted fabric to form the second layer.

A seventeenth embodiment can include the method of the sixteenth embodiment, further comprising forming the nonwoven fabric of the second layer by one of: spunlacing, needle-punching, or a combination thereof.

An eighteenth embodiment can include the method of the sixteenth or seventeenth embodiments, wherein the nonwoven fabric of the second layer comprises approximately 40-80 wt % of para-aramid fibers and approximately 20-60 wt % of oxidized polyacrylonitrile fibers.

A nineteenth embodiment can include the method of any of the sixteenth to eighteenth embodiments, wherein the woven or knitted fabric of the second layer comprises approximately 40-80 wt % meta-aramid fibers.

In a twentieth embodiment, a personal protection equipment textile may comprise a first layer of woven or knitted material configured to face an arc flash; and a second layer configured to face a user's skin, wherein the second layer is formed by quilting a nonwoven fabric to a woven or knitted fabric, wherein the second layer comprises at least one oxidized polyacrylonitrile fiber, and wherein the total areal density of the personal protection equipment textile is less than approximately 500 grams per square meter.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A material for arc flash protection comprising:
a first layer of textile material configured to face an arc flash, the first layer comprising a woven or knitted fabric; and
a second layer of textile material configured to face a user's skin, the second layer comprising a quilted fabric having at least one oxidized polyacrylonitrile fiber.

2. The material of claim 1, wherein the material comprises an areal density of less than approximately 600 grams per square meter.

3. The material of claim 1, wherein the material comprises an areal density of less than approximately 500 grams per square meter.

4. The material of claim 1, wherein the material comprises an areal density of approximately 475 grams per square meter.

5. The material of claim 1, wherein the first layer comprises a combination of four or more fibers.

6. The material of claim 1, wherein the first layer comprises approximately 40-80 wt % meta-aramid fibers.

7. The material of claim 1, wherein the second layer comprises a nonwoven fabric placed over a woven or knitted fabric.

8. The material of claim 7, wherein the nonwoven fabric of the second layer comprises at least two fibers.

9. The material of claim 7, wherein the nonwoven fabric of the second layer comprises approximately 40-80 wt % of para-aramid fibers and approximately 20-60 wt % of oxidized polyacrylonitrile fibers.

10. The material of claim 7, wherein the woven or knitted fabric of the second layer comprises a combination of four or more fibers.

11. The material of claim 7, wherein the woven or knitted fabric of the second layer comprises approximately 40-80 wt % meta-aramid fibers.

12. The material of claim 7, wherein the nonwoven fabric of the second layer is formed by one of: spunlacing, needle-punching, or a combination thereof.

13. The material of claim 7, wherein the nonwoven fabric of the second layer comprises an areal density of between approximately 60 and 150 grams per square meter.

14. A method of forming a material for protection from arc flash, the method comprising:
providing a first layer of textile material configured to face an arc flash, the first layer comprising a woven or knitted fabric;
quilting one or more layers of material to form a second layer of textile material configured to face a user's skin, the second layer comprising at least one oxidized polyacrylonitrile fiber; and
attaching the first layer to the second layer to form a completed textile.

15. The method of claim 14, further comprising shaping the completed textile into a personal protection equipment to be worn by a user.

16. The method of claim 14, wherein quilting one or more layers comprises placing a nonwoven fabric over a woven or knitted fabric, and quilting the nonwoven fabric to the woven or knitted fabric to form the second layer.

17. The method of claim 16, further comprising forming the nonwoven fabric of the second layer by one of: spunlacing, needle-punching, or a combination thereof.

18. The method of claim 16, wherein the nonwoven fabric of the second layer comprises approximately 40-80 wt % of para-aramid fibers and approximately 20-60 wt % of oxidized polyacrylonitrile fibers.

19. The method of claim 16, wherein the woven or knitted fabric of the second layer comprises approximately 40-80 wt % meta-aramid fibers.

20. A personal protection equipment textile comprising:
a first layer of woven or knitted material configured to face an arc flash; and
a second layer configured to face a user's skin, wherein the second layer is formed by quilting a nonwoven fabric to a woven or knitted fabric, wherein the second layer comprises at least one oxidized polyacrylonitrile fiber, and wherein the total areal density of the personal protection equipment textile is less than approximately 500 grams per square meter.
